(19) United States
(12) Patent Application Publication
(10) Pub. No.: US 2017/0279806 A1
(43) Pub. Date: Sep. 28, 2017

(54) Authentication in a Computer System

(71) Applicants: Sami Marttinen, Jersey City, NJ (US); Josh Bregman, Acton, MA (US); Wayne Delisser, Lake Forest, CA (US); Tatu J. Ylonen, Espoo (FI)

(72) Inventors: Sami Marttinen, Jersey City, NJ (US); Josh Bregman, Acton, MA (US); Wayne Delisser, Lake Forest, CA (US); Tatu J. Ylonen, Espoo (FI)

(21) Appl. No.: 15/458,361

(22) Filed: Mar. 14, 2017

Related U.S. Application Data
(60) Provisional application No. 62/307,773, filed on Mar. 14, 2016.

(51) Int. Cl. H04L 29/06

(52) U.S. Cl. CPC H04L 63/10; H04L 63/0281; H04L 63/061; H04L 63/0435; H04L 63/0442; H04L 63/168

(57) ABSTRACT

An authentication arrangement comprises a first security protocol server configured to manage authenticators for log in to a first set of hosts managed by the first security protocol server and a second security protocol server. The hosts are adapted to accept access requests based on information on authenticators. The first security protocol server is configured to transfer authenticators used to log in to the first set of hosts to the second security protocol server. The hosts in the first set of hosts then use information stored on the second security protocol server for accepting access requests.

### FIELD OF THE INVENTION

The disclosure relates to authentication using security protocol servers in a computer network system.

### BACKGROUND

Authentication can be used for securing login to hosts in a computer system. SSH (Secure Shell) is a commonly used security protocol for automated logins over computer networks. Detailed description of SSH protocol is available in IETF RFC 4251, RFC 4253, and RFC 4254. The SSH Protocol defines, among other things, an authentication mechanism called public key authentication where public key cryptography is used for authentication. A client is configured with a private key, called an identity key. A private key is preferably specific to a user and identifies a single user. Servers may be configured with one or more public keys that allow authentication using the corresponding private keys. Such public keys are called authorized keys, and are typically configured separately for each user on a server. The authorized keys are typically stored in files called authorized keys files in varying locations on servers. Technically the authentication works by computing a digital signature of a session-specific value (session identifier) at a client using the private key, and verifying the signature at the server using the corresponding public key. Jointly, the authorized keys and identity keys are called SSH user keys. The SSH protocol also uses host keys for authenticating hosts. All these keys are jointly called SSH keys.

The use of public key authentication has become ubiquitous in enterprises. This can be especially the case with the increase in machine-to-machine authentication applications. Enterprises can have even millions of authorized keys configured in their information systems.

The OpenSSH™ implementation of the SSH protocol supports a configuration option called AuthorizedKeysCommand, which can be used for retrieving the authorized keys for a user. It is known to be used in some environments for fetching keys from an LDAP (Lightweight Directory Access Protocol) directory.

Most SSH protocol client implementations also support using what is called an authentication agent for accessing an identity key. Using the agent, the client does not actually need access to the private key. Instead, the client only needs to be able to perform operations on the private key.

Configuration, management, and auditing of SSH keys has become complicated in large heterogeneous environments. This can be particularly the case when taking into account elastically scaling cloud services and microservice technologies, such as containers, and DevOps.

A need therefore exists for easier authentication architecture for access to host, for example machine-to-machine access that is compatible with existing scripts and clients and servers.

### SUMMARY

In accordance with an aspect there is provided an authentication apparatus comprising a first security protocol server configured to manage authenticators used to log in to a first set of hosts managed by the first security protocol server, the hosts being adapted to accept access requests based on information on authenticators, wherein the first security protocol server is further configured to transfer authenticators used to log in to the first set of hosts to a second security protocol server and cause the hosts in the first set of hosts to use information stored on the second security protocol server for accepting access requests.

In accordance with another aspect there is provided an apparatus for an authentication system wherein hosts are adapted to accept access requests based on information on authenticators and the authentication system comprises a first security protocol server configured to manage authenticators used to log in to a first set of hosts, the apparatus comprising at least one processor, and at least one memory for storing instructions that, when executed, cause the apparatus to provide a second security protocol server configured to receive authenticators used to log in to the first set of hosts from the first security protocol server and cause the hosts in the first set of hosts to use information on authenticators from the second security protocol server for accepting access requests.

In accordance with another aspect there is provided a method for authentication in a system wherein hosts are adapted to accept access requests based on information on authenticators, the method comprising managing authenticators used to log in to a first set of hosts by a first security protocol server, transferring at least one authenticator for log in to the first set of hosts to a second security protocol server, and causing at least one host in the first set of hosts to use information stored on the second security protocol server for accepting access requests.

In accordance with yet another aspect there is provided a method for authentication in a system wherein hosts are adapted to accept access requests based on information on authenticators and the system comprises a first security protocol server configured to manage authenticators used to log in to a first set of hosts, the method comprising: receiving at a second security protocol server authenticators for log in to the first set of hosts from the first security protocol server; and causing the hosts in the first set of hosts to use information on authenticators from the second security protocol server for accepting access requests.

In accordance with a more detailed aspect the first security protocol server is adapted to insert an authorized key of the second security protocol server in at least one host in the first set of host managed by the first security protocol server.

At least one of the first security protocol server and the second security protocol server may be configured to send to at least one host in the first set of hosts instructions to use the second security protocol server as the source for authorized keys.

The first security protocol server may be configured to scan the authorized keys in the hosts of the first set of hosts.

The second security protocol server may further be configured to manage access to a second set of hosts.

The first set of hosts can belong to a first environment and the second set of hosts can belong to a second environment. The first environment may be a legacy environment. The second environment may be a cloud environment.

The authenticator may be a public key used as an authorized key. The authenticator may be a private key.

The first security protocol server may comprise a key manager server. The second security protocol server may comprise a centralized repository of credentials. The centralized repository of credentials may comprise a Lightweight Directory Access Protocol (LDAP) directory or an Active Directory (AD).

Information stored in the second protocol server may comprise the received authenticators and information regarding individual authenticators whether they are authorized to access a given host.

In accordance with more detailed aspects an authorized key is fetched from a secure store, a service identifier is used to obtain a private key from a secure store, and/or a credential stored in a root-owned location is used to show to a secure store that a server or a client is authorized to fetch keys for a user from the secure store.

One or more authorized keys can be discovered from a host where after at least one of the authorized keys is stored in a secure store external to the host. The at least one authorized keys is then eliminated from the host.

A host can be configured for authentication without locally stored authorized keys. The configuration causes the host to fetch by a helper computer code product authorized keys from a secure store external to the host, and a security protocol server on the host to use the helper program as an authorized key command for at least one user and a security protocol server on the host to not use any other authorized keys than those provided by the helper program for at least one user.

A host can also be configured for authentication without locally stored private keys by installing an agent computer program product for use of authorized keys from a secure store external to the host and configuring the agent computer program product to be used for a security protocol client for using at least one private key stored in a secure store external to the host.

### BRIEF DESCRIPTION OF FIGURES

FIG. 1 shows different IT environments

FIG. 2 shows a process for modifying storage of credentials

FIG. 3 shows management of credentials with separate mechanisms

FIG. 4 shows a step in integrating management of credentials

FIG. 5 shows a step in integrating management of credentials

FIG. 6 shows a step in integrating management of credentials

FIG. 7 shows integrated management of credentials

### DETAILED DESCRIPTION

In the following certain examples relating to aspects of managing authorisation to access hosts in a computerized system are described with reference to the appended drawings. A computerized system can be understood as a network comprising data processing entities such as computers and/or virtual machines, containers, user accounts, directories and/or groups of computers, and other associated components, together with associated software. A physical computer is typically a data processing unit comprising at least one processor, at least one memory and an operating system. A virtual machine (VM) in turn provides functionality of a physical computer by emulating a computer system. A virtual machine is not necessarily provided by a given physical entity but can be provided in what is known as the “cloud”. VM implementations may involve specialized hardware, software, or a combination. Each virtual machine runs a unique operating system. A specific software application runs between the hardware and the operating system for creating and running a VM.

A more recent development is operating system level virtualization. The operating system level virtualization allows resources of a computer to be partitioned via the kernel's support for multiple isolated user space instances. Such virtual instances sharing operating system resources are called containers. A characteristic of containers is that they are fast to start (“open”) for the task or application. Containers sit on top of a physical server and its host operating system. Containers can thus be described as simplified virtual machines, a difference being that containers do not have their own operating system. Containers may nevertheless look and feel like real machines to the end users. An advantage of containers is that they are computationally light and quick to start. Pods are groups of containers created or destroyed together, usually belonging to the same logical application.

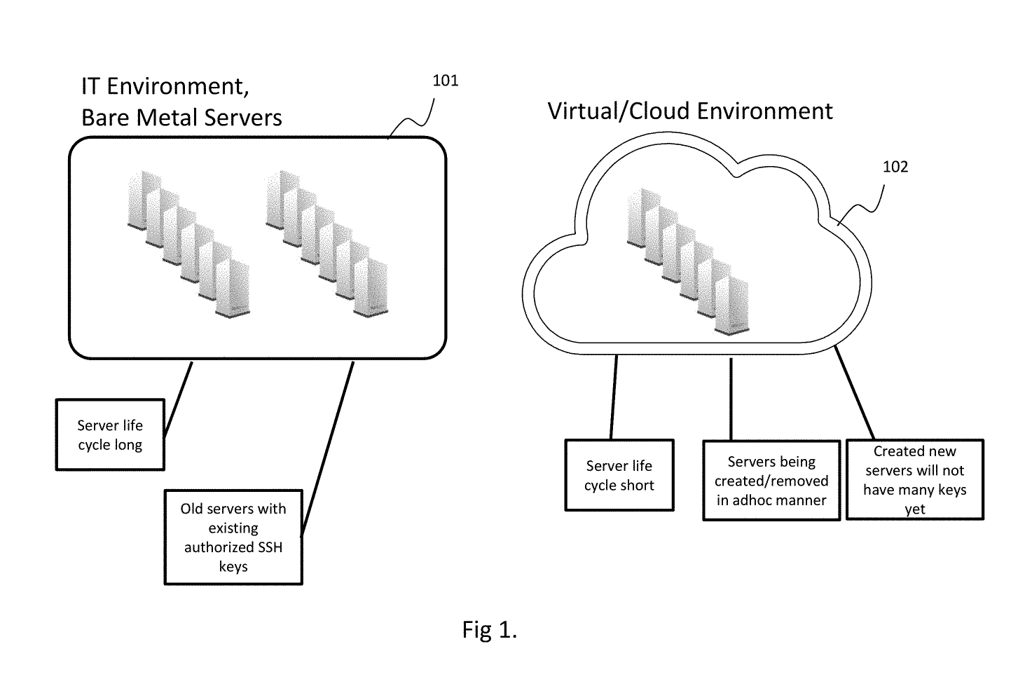

FIG. 1 shows an example of a computer network system where two different IT (information technology) environments are provided. The first environment 101 comprises legacy servers with long life cycles and long term trust relationships. Such trust relationships are typically characterized by authorized keys such as authorized SSH keys. The second environment 102 is a cloud based environment, where computation is shared to virtual machines and/or containers. In the second environment the operation of the system is based on virtual computing entities with short lifecycle, which entities can be created and removed in adhoc manner. Entities with short lifecycles typically have less keys to manage. The lifetime of the keys can also be much shorter than in the first environment.

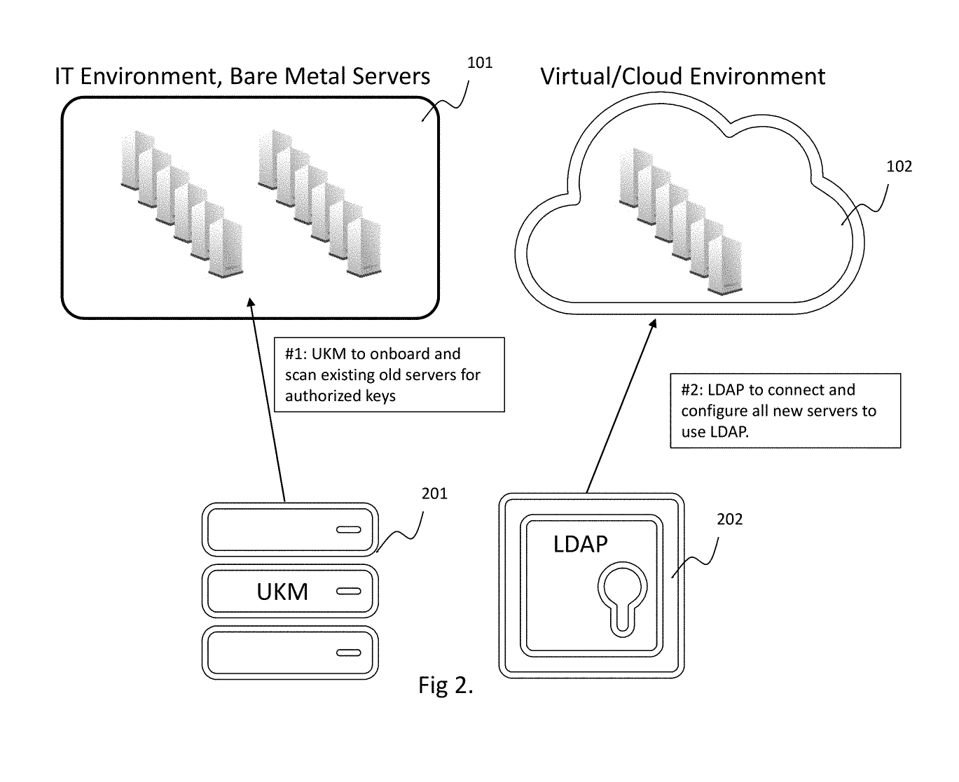

FIG. 2 shows an architecture for managing the authorized keys in the system of FIG. 1. The keys of first environment 101 are managed using a key management system 201. An example of key management systems is the Universal Key Manager® of SSH Communications Security. The key management system for the legacy environment may be configured to scan authorized keys from the hosts such as the servers it manages. This can be done e.g. by causing a script to be run in each of the hosts. The key manager can store information on such keys either internally in the key management server or externally in a separate server.

The keys and/or other credentials used to control access in the second environment are managed using a credential management system 202 of the second environment 102. Examples of such include the LDAP (Lightweight Directory Access Protocol) and Active Directory (AD).

Users of the IT systems can access environments of both of the above described types. It is therefore advantageous to have a common management and control for the trust relationships and authorized keys in both systems.

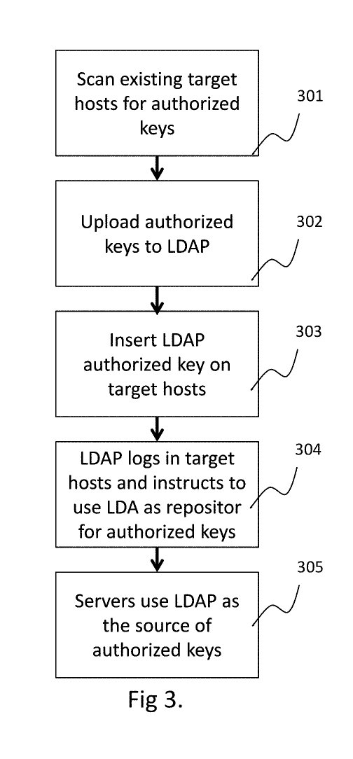

FIG. 3 shows a process performed on the system of FIG. 2 according to one embodiment. In step 301, the key management system 201 of the legacy environment 101 scans the host managed by the key management system 201 of the legacy environment 101 to get information on authorized keys used by the managed hosts and the trust relationships to the hosts. In step 302 the key management system 201 of the legacy environment 101 uploads the authorized keys to the credential management system 202 of the second environment 102. This step gives the credential management system 202 visibility on the authorized keys and the trust relationships used in the first environment 101, in addition to the information it already holds on the second environment 102.

In step 303, the key management system 201 inserts the public key of the credential management system 202 in the hosts of the first environment 101 as an authorized key to establish a trust relationship between the hosts of the first environment 101 and the credential management system 202 of the second environment 102. The key management server may also instruct the hosts to accept instructions on new repository for authorized keys from the credential management server. Alternatively, this instruction may have been configured in the hosts previously, for example by the key management system 201 or a separate host configuration system (not shown). Step 303 enables the credential management system 202 to access the hosts of the first environment 101 and to log in the target hosts in step 304 and to instruct the hosts to use the credential management system 202 as their repository for authorized keys. One further possibility, to inform the hosts that the LDAP (or another depository) will instruct them to use itself for keys, and that the hosts should accept requests from the LDAP, is that the key management system certifies the LDAP and the LDAP then uses this certificate to indicate the hosts that the request coming from LDAP is acceptable.

Following step 304, the hosts of the first environment 101 can use the credential management system 202 of the second environment 102 as the source of authorized keys when making their decisions on whether or not to allow access requests from other hosts and from clients.

The key management system 201 may continue to monitor the hosts in the first environment to verify if the hosts continue to use local authorized keys. The key management system may, on a need basis, perform key management actions to ensure the access requests are accepted or rejected based on the centrally managed information stored in the credential management system 202 on authorized keys. The key management system 202 may also continue to manage other environments, for example other legacy environments, where the authorized key information is desired to be kept separate from the credential management system 202.

The key management system may also monitor the use of keys and other credentials in the second environment, for example a cloud environment, to monitor if accounts in the second environment use locally stored authorized keys, and on a need basis to perform key management actions to ensure the access requests in the second environment 102 are accepted or rejected based on the centrally managed information stored in the credential management system 202 on authorized keys. The key management system 201 may also continue to perform operations on the private keys of the hosts in the first and/or second environment.

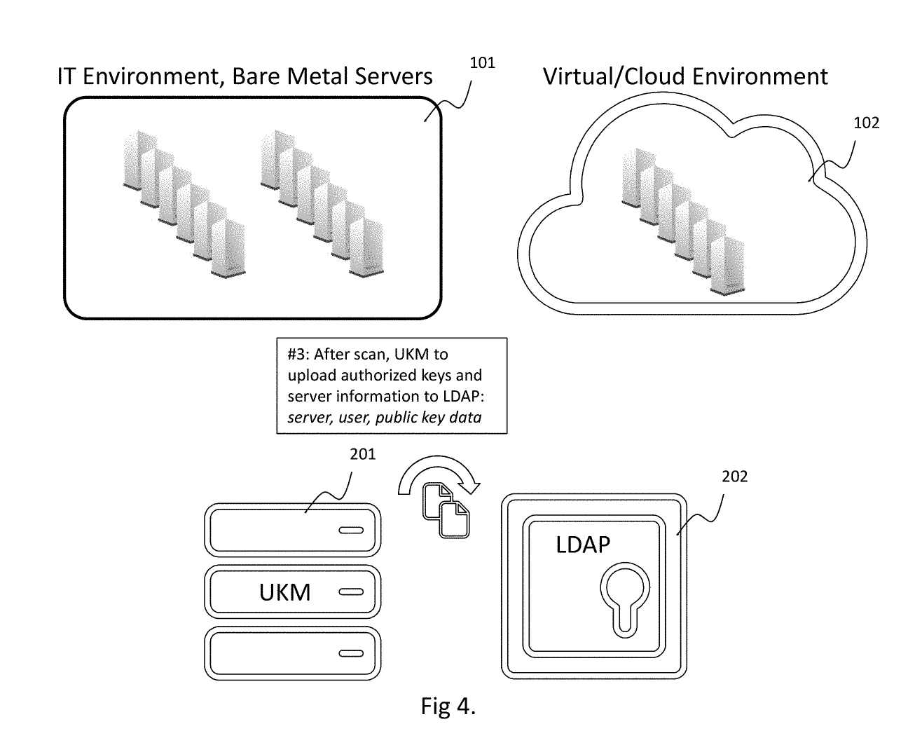

FIG. 4 shows an example of the step of uploading authorized keys and host information from the key management system 201 to the credential management system 202. A trust relationship is created, for example in the process of configuring the key management server 201 or the credential management server 202, between the key management system 201 and the credential management system 202. The host information may comprise the private key or more than one private keys used by the host. The key management server 201 may initiate the communication using its identity where the corresponding public key is configured in the credential management system 202 as an authorized key. The key management server 201 may have the public key of the credential management system 202, and encrypt information on authorized keys at the hosts in the first environment 101 and information on the hosts in the first environment 101. The first key management server may then send this information encrypted using the public key of the credential management server 202 to the credential management system 202. The credential management system can decrypt the encrypted information using its own private key. Alternatively, the key management server 201 and the credential management server 202 may agree on at least one session specific key which is used to encrypt information on authorized keys at the hosts in the first environment 101 and information on the hosts in the first environment 101, and to decrypt the message at the credential management server 202.

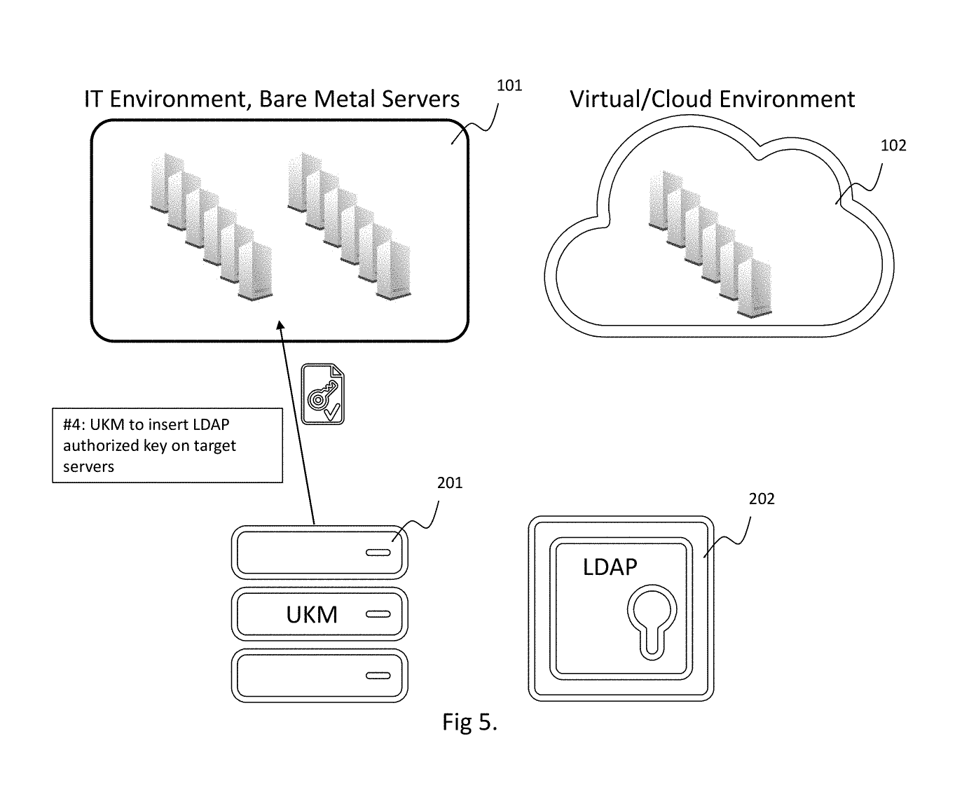

FIG. 5 shows the step of inserting the public key of the credential management server 202 in the hosts in the first environment 101 managed by the key management server 201. The key management server 201 may indicate the hosts of the new repository for authorized keys in the same message, in a different message, or the host may have been preconfigured, for example using the host configuration system (not shown) to be prepared to accept a request to start using the credential management system 202 as the new repository for authorized keys, and/or to allow operations on private keys to be performed by the credential management server 202.

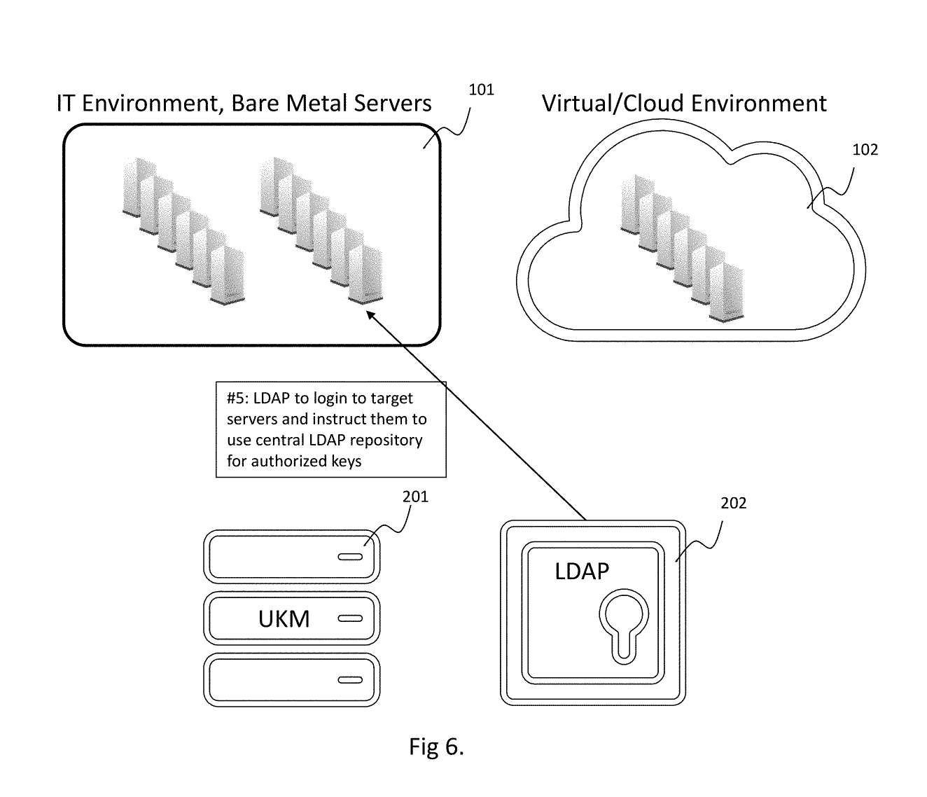

FIG. 6 shows the step of the credential management server 202 taking control of the key operations to the hosts in the first environment. The credential management server 202 logs into the hosts using its own private key, and the access is granted as the corresponding public key was stored as an authorized key in the hosts.

Alternatively, the hosts in the first environment may be instructed to use the credential management server 202 as the repository for authorized keys directly by the key management server 201 in the previous step. Using a security protocol, the credential management server 202 can instruct the hosts to start using the credential management server 202 as the repository for authorized keys. In accordance to the security protocol, the hosts accept this request.

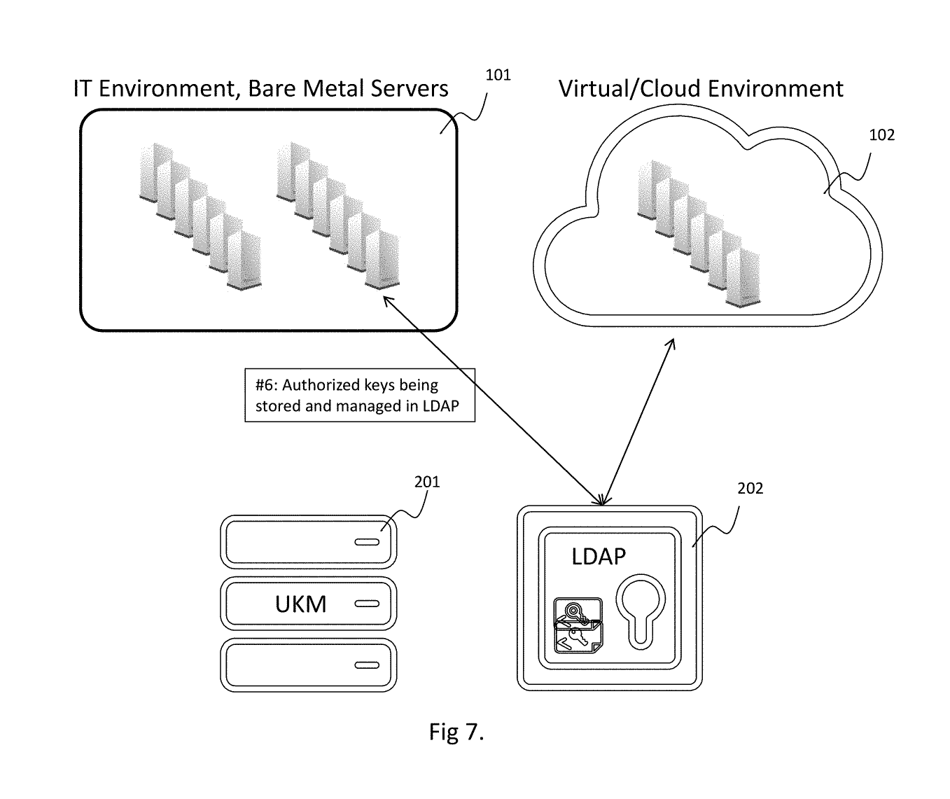

FIG. 7 shows the resulting system, where the authorized keys and server security information of both the first environment 101 and the second environment 102 are managed using the credential management server 202.

Authorized authenticators, available authenticators, and policy can thus be configured in a repository, preferably in a centralized repository, that is separate from key management servers. The disclosed mechanisms are particularly useable in machine-to-machine authentication. Machine to machine authentication requires keys to be automatically managed because manual provisioning would be too slow. Issues requiring automatic resolving can also arise, e.g., where services are provided in cloud because the physical servers implementing the service can change, and the change can happen very quickly.

In one embodiment of the invention, authorized keys files are eliminated from servers using a suitable helper program configured using the AuthorizedKeysCommand configuration option or equivalent. In an embodiment, identity keys are eliminated by providing a helper program that acts as an SSH agent that provides access to the identity keys.

The identity keys may be stored in a secure store that need not reside on the same host. The secure store can comprise, for example, a HSM (Hardware Security Module,), a TPM (Trusted Platform Module), a local key vault implemented in software, a networked key vault or a networked HSM, a smartcard, a database, a directory service, or other suitable key and/or information store or any combination of these.

In an embodiment, a key discovery mechanism is provided that
finds one or more authorized keys and/or identity keys on one or more hosts;
stores at least one of the identity keys in a secure store;
eliminates said at least one of the identity keys from the one or more hosts;
for at least one of the authorized keys, stores in the secure store an indication that a private key corresponding to the authorized key is authorized to authenticate as the user account for which the authorized key was authorized on the server, and eliminates the authorized key from a server from which it was found.

The eliminating may mean, for example, removing the keys from the host or reconfiguring the host to no longer use the keys for authentication. The keys could be kept on the host as backups for a period of time.

The indication may be, for example, an authorized key entry (possibly including key options such as from stanza or a command restriction) or a key fingerprint (possibly with key options) associated and an identifier for a user account (optionally associated with a host, an Active Directory Domain, a NIS (Network Information Service) domain, Kerberos realm, or other suitable authentication scope). The indications can be stored in the LDAP, and indicate what the therein stored public key is authorized to do, encoded e.g. in the above manner.

In an embodiment, all authorized keys and identity keys from a host are discovered and stored in a secure store. A software product for authorized key command functions may be provided. For example, an AuthorizedKeysCommand helper program can be provided that fetches authorized keys for a user from the secure store during authentication

An agent program is provided that uses a version of the ssh-agent protocol to communicate with an SSH client. The agent program may be started when the user logs in, or by running the SSH client using a separate command that acts as the agent and starts the SSH client as a subprocess. The agent can fetch the identity keys belonging to the user that it runs as, and makes them available to the SSH client using the SSH client protocol. In one embodiment, the keys are copied to a local file system (e.g., a memory file system) and the SSH client uses them from there. The agent may add a “-i” option to the SSH client to specify the path of the key file to use. In another embodiment, the agent forwards requests to perform operations using one or more private keys to the secure store.

In this manner, the authorized keys and identity keys never need to be stored on either the SSH server host or the SSH client host. For newly provisioned hosts, for example in elastic cloud environments, the keys are immediately available without having to fetch them.

The AuthorizedKeysCommand helper program and the agent program may use a credential (e.g., shared secret or private key) stored on the host to show that they are authorized to obtain authorized keys and/or identity keys for the host. The credential may be stored in a root-owned file and the helper program and agent may be configured to set user identifier to root when they are run; they may then read the credential and drop privileges before performing other operations.

The helper program and the agent program may also utilize an identifier for a class of hosts, services, containers, or similar (e.g., the group of hosts or containers belonging to the server) to determine which authorized keys and/or identity keys it should obtain from the secure store and make available to the SSH client and/or server. Such identifier can be called a service identifier. A service identifier may identify a single entity (e.g., Amazon™ instance identifier) or a group of entities (e.g., all Amazon™ instances belonging to a particular application or service, such as in elastic scaling configurations). The determining may take place in the secure store or in the helper program or agent. Keys stored in the secure store may be associated with a service identifier.

In an embodiment, a cloud instance identifier can be used to determine which authorized keys and/or identity keys to make available to a host.

Policy rules may also be configured in the secure store or otherwise to control which authorized keys and/or identity keys are available to which hosts or services.

In an embodiment, the helper program, the agent, or an auxiliary program on the host caches the authorized keys and/or the identity keys, if any, obtained for a user account on the host in a local file on the host, enabling them to be used even if the secure store is unavailable at the time of the login.

In an embodiment, authorized keys and identity keys are managed in the secure store. To install a new authorized key for a user on a host, it is simply added for that user and host in the secure store. Alternatively it may be enabled by a rule change or other similar mechanism.

In an embodiment, the agent looks up the command line used for the SSH client. If the agent runs the SSH client as a subprocess, it may directly inspect the command and arguments. If it uses a socket to communicate with the client, it may, for example, use the “Isof” command (on linux) or equivalent to determine which process is at the other end of the socket, and use the equivalent of the “ps” command to determine the arguments that command was given. The agent may identify a “-i” option from the command line and use that to select the appropriate identity key to use for the client. It may, for example, choose to only display a key identified by that path to the client. The path may be stored in the secure store with the key when the key is stored in the vault during discovery.

In an embodiment, at least one identity key is encrypted using a passphrase. During discovery, such keys are stored in the secure store. A mechanism is provided for providing the passphrase of the key file for decrypting the key. The passphrase may be supplied before, during, or after discovering the key.

In an embodiment, when an SSH client attempts to use the key, the passphrase is obtained by calling an ssh-askpass program (possibly overridden by an environment variable) and the obtained passphrase is used for decrypting one or more keys in the secure store. In an embodiment, a special version of the ssh-askpass program sends all passphrases that have been used for decrypting keys into the secure store, and these passphrases will be used for attempting to decrypt keys (immediately or sometime after obtaining the passphrase).

An agent program may be used in a similar manner for host keys. However, host keys are normally not associated with specific users but relate to the entire host or to a particular security protocol server instance running on the host.

An SSH server may be configured to use only authorized keys provided by an AuthorizedKeysCommand by, e.g., setting the authorized keys file path to /dev/null (some servers support multiple paths, in which case all such paths may need to be set to this value).

The agent and/or helper program may also be implemented as part of a security protocol client or server, respectively, or a client or server may use external programs to perform related operations.

The various aspects and embodiments may be combined to form new embodiments. “An embodiment” or “one embodiment” refers to classes of embodiments and not necessarily the same embodiment.

The required data processing apparatus may be provided by means of one or more data processors. At last a part of the operations may be provided in virtualized environment. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. The memory or memories may be of any type suitable to the technical environment and may be implemented using any suitable data storage technology, such as semiconductor based memory devices, magnetic memory devices and systems, optical memory devices and systems, fixed memory and removable memory. In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various aspects, examples and features of various examples discussed above can be combined in manners not specifically shown by the drawings and/or described above. The foregoing description provides by way of exemplary and non-limiting examples a full and informative description of exemplary embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

We claim:

1. An authentication apparatus comprising:
a first security protocol server configured to manage authenticators used to log in to a first set of hosts managed by the first security protocol server, the hosts being adapted to accept access requests based on information on authenticators,
wherein the first security protocol server is further configured to transfer authenticators used to log in to the first set of hosts to a second security protocol server and cause the hosts in the first set of hosts to use information stored on the second security protocol server for accepting access requests.

2. The authentication apparatus of claim 1, wherein the first security protocol server is adapted to insert an authorized key of the second security protocol server in at least one host in the first set of host managed by the first security protocol server.

3. The authentication apparatus of claim 1, wherein at least one of the first security protocol server and the second security protocol server is configured to send to at least one host in the first set of hosts instructions to use the second security protocol server as the source for authorized keys.

4. The authentication apparatus of claim 1, wherein the first security protocol server is configured to scan the authorized keys in the hosts of the first set of hosts.

5. The authentication apparatus of claim 1, wherein the second security protocol server is further configured to manage access to a second set of hosts.

6. The authentication apparatus of claim 5, wherein the first set of hosts belong to a first environment and the second set of hosts belongs to a second environment.

7. The authentication apparatus of claim 6, wherein the first environment is a legacy environment, and the second environment is a cloud environment.

8. The authentication apparatus of claim 1, wherein the authenticator is a public key used as an authorized key.

9. The authentication apparatus of claim 1, wherein the authenticator is a private key.

10. The authentication apparatus of claim 1, wherein the first security protocol server comprise a key manager server and the second security protocol server comprises a centralized repository of credentials.

11. The authentication apparatus of claim 10, wherein the centralized repository of credentials comprises a Lightweight Directory Access Protocol (LDAP) directory or an Active Directory (AD).

12. An apparatus for an authentication system wherein hosts are adapted to accept access requests based on information on authenticators and the authentication system comprises a first security protocol server configured to manage authenticators used to log in to a first set of hosts, the apparatus comprising at least one processor, and at least one memory for storing instructions that, when executed, cause the apparatus to provide a second security protocol server configured to receive authenticators used to log in to the first set of hosts from the first security protocol server and cause the hosts in the first set of hosts to use information on authenticators from the second security protocol server for accepting access requests.

13. The apparatus of claim 12, wherein at least one of the first security protocol server and the second security protocol server is configured to send to at least one host in the first set of hosts instructions to use the first security protocol server as the source for authorized keys.

14. The apparatus of claim 12, wherein the second security protocol server is further configured to manage access to a second set of hosts.

15. The apparatus of claim 12, wherein the first set of hosts belong to a first environment and the second set of hosts belongs to a second environment.

16. The apparatus of claim 15, wherein the first environment is a legacy environment, and the second environment is a cloud environment.

17. The authentication apparatus of claim 12, wherein said information stored in the second protocol server comprises the received authenticators and information regarding individual authenticators whether they are authorized to access a given host.

18. A method for authentication in a system wherein hosts are adapted to accept access requests based on information on authenticators, the method comprising:
managing authenticators used to log in to a first set of hosts by a first security protocol server,
transferring at least one authenticator for log in to the first set of hosts to a second security protocol server, and
causing at least one host in the first set of hosts to use information stored on the second security protocol server for accepting access requests.

19. The authentication method of claim 18, comprising inserting an authorized key of the second security protocol server in at least one host in the first set of host managed by the first security protocol server.

20. The authentication method of claim 18, wherein the causing of at least one host to use the second security protocol server comprises at least one of the first security protocol server and the second security protocol server sending to the at least one hosts in the first set of hosts instructions to use the second security protocol server as the source for authorized keys.

21. The authentication method of claim 18, comprising at least one of
fetching an authorized key from a secure store,
using a service identifier to obtain a private key from a secure store, and
using a credential stored in a root-owned location to show to a secure store that a server or a client is authorized to fetch keys for a user from the secure store.

22. The authentication method of claim 18, comprising:
discovering, by a computer, one or more authorized keys from a host;
storing at least one of the authorized keys in a secure store external to the host; and
eliminating the at least one authorized keys from the host.

23. The authentication method of claim 18, comprising configuring a host for authentication without locally stored authorized keys, the configuring comprising:
fetching by a helper computer code product authorized keys from a secure store external to the host;
configuring a security protocol server on the host to use the helper program as an authorized key command for at least one user; and
configuring a security protocol server on the host to not use any other authorized keys than those provided by the helper program for at least one user.

24. The authentication method of claim 18, comprising configuring a host for authentication without locally stored private keys, the configuration comprising:
installing an agent computer program product for use of authorized keys from a secure store external to the host; and
configuring the agent computer program product to be used for a security protocol client for using at least one private key stored in a secure store external to the host.

25. A method for authentication in a system wherein hosts are adapted to accept access requests based on information on authenticators and the system comprises a first security protocol server configured to manage authenticators used to log in to a first set of hosts, the method comprising:
receiving at a second security protocol server authenticators for log in to the first set of hosts from the first security protocol server; and
causing the hosts in the first set of hosts to use information on authenticators from the second security protocol server for accepting access requests.
